(19) United States
(12) Patent Application Publication
(10) Pub. No.: US 2017/0063635 A1
(43) Pub. Date: Mar. 2, 2017

(54) APPARATUS AND METHOD FOR CONTROLLING NETWORK SERVICE IN ENVIRONMENT OF INTERWORKING BETWEEN SOFTWARE DEFINED NETWORK AND LEGACY NETWORK

(71) Applicant: ELECTRONICS AND TELECOMMUNICATIONS RESEARCH INSTITUTE, Daejeon (KR)

(72) Inventor: Yun-Chul CHOI, Daejeon (KR)

(73) Assignee: ELECTRONICS AND TELECOMMUNICATIONS RESEARCH INSTITUTE, Daejeon (KR)

(21) Appl. No.: 14/954,100

(22) Filed: Nov. 30, 2015

(30) Foreign Application Priority Data
Aug. 24, 2015 (KR) 10-2015-0118711

(51) Int. Cl. H04L 12/24; H04L 12/931

(52) U.S. Cl. CPC H04L 41/12; H04L 41/50; H04L 49/35; H04L 41/06; H04L 41/0631

(57) ABSTRACT

Disclosed is a network service control device and method in an environment in which a Software Defined Network (SDN) and a legacy network are connected to each other. The network service control device according to the present invention includes: a first network acquisition unit for acquiring first network information corresponding to the SDN; a second network information acquisition unit for acquiring second network information corresponding to the legacy network; a control message creation unit for creating a service control message for controlling a service of the network environment in which the SDN and the legacy network are connected to each other, based on at least one of the first network information and the second network information; and a service control unit for controlling the service of the network environment by transmitting the service control message to at least one network switch module included in the network environment.

### CROSS REFERENCE TO RELATED APPLICATION

This application claims the benefit of Korean Patent Application No. 10-2015-0118711, filed Aug. 24, 2015, which is hereby incorporated by reference in its entirety into this application.

### BACKGROUND OF THE INVENTION

1. Technical Field

The present invention relates to a network service control technique capable of adding and controlling a network service using a Software Defined Network (SDN) in an environment in which a legacy network and an SDN coexist.

2. Description of the Related Art

When a network is operated using existing legacy network equipment, there are software and hardware limitations in adding new network functionality or in applying a new protocol to the network. Also, when new hardware is added to the network, there may be a problem of compatibility with existing network equipment.

As network structures for solving these problems, techniques relating to a Software Defined Network (SDN), such as OpenFlow, which was recently proposed, are used. These techniques control network equipment in a separate module through a centralized method according to standard protocols and open interfaces provided by switches. Such an SDN enables fast innovation in networking technology by facilitating interworking between heterogeneous devices, and thus is actively used in various environments such as data centers, cloud services, and the like.

However, when there is no interworking between an SDN and legacy network equipment, a problem of synchronization of network topology information may occur, which may lead to packet loss or network looping. Also, because it is difficult to predict resources, there may be a problem in supporting QoS.

Therefore, required is a network service control technique capable of maintaining compatibility with legacy network equipment using an SDN, and adding or removing new protocols and new network services while updating information about overall network topology.

In connection with this, Korean Patent Application Publication No. 10-2012-0041454 discloses a technology related to “Legacy service system based on IMS and method of controlling the same.”

### SUMMARY OF THE INVENTION

An object of the present invention is to enable interworking between an SDN and an existing legacy network.

Also, another object of the present invention is to provide a control method capable of adding and removing a network service or a protocol in an environment in which a legacy network and an SDN are connected to each other.

In order to accomplish the above object, a network service control device in an environment in which a Software Defined Network (SDN) and a legacy network are connected to each other, according to the present invention, include: a first network information acquisition unit for acquiring first network information corresponding to the SDN; a second network information acquisition unit for acquiring second network information corresponding to the legacy network; a control message creation unit for creating a service control message for controlling a service of the network environment in which the SDN and the legacy network are connected to each other, based on at least one of the first network information and the second network information; and a service control unit for controlling the service of the network environment by transmitting the service control message to at least one network switch module included in the network environment.

The first network information acquisition unit may acquire the first network information including at least one of topology information, statistical information, host information, and SDN switch information, based on an OpenFlow Protocol.

The second network information acquisition unit may acquire the second network information including at least one of topology information, statistical information, host information, and legacy network module information, based on at least one of a Simple Network Management Protocol (SNMP) and a Network Configuration Protocol (Netconf).

The service control message may correspond to any one of a service creation message for adding a new service to the network environment and a service removal message for removing an existing service from the network environment.

The at least one network switch module may include at least one of at least one SDN switch and at least one legacy network switch.

The service control unit may update at least one of a Flow Table corresponding to the at least one SDN switch and a LookUp Table corresponding to the at least one legacy network switch, by transmitting the service control message.

When a new service is added to the network environment, the service control unit may add information about an entry corresponding to a new service packet to the Flow Table by delivering the service creation message to the SDN switch, and add information about an action corresponding to the new service packet to the Flow Table depending on whether the new service packet is received.

When an existing service is removed from the network environment, the service control unit may deactivate a service module corresponding to the existing service, and simultaneously deliver the service removal message to the SDN switch so as to delete information corresponding to the existing service from the Flow Table.

The LookUp Table may be updated when the legacy network switch receives at least one of the service creation message and a response packet to the new service packet.

The LookUp Table may delete information about the existing service after the legacy network switch does not receive a response packet to a packet corresponding to the existing service during a time period corresponding to a timeout value.

The network service control device may further include an error verification unit for checking errors between the first network information and the second network information.

The error verification unit may create one or more nodes corresponding to at least one of the at least one network switch module, the host, and the legacy network module, and check errors by analyzing a relationship between the one or more nodes.

Also, a network service control method in an environment in which a Software Defined Network (SDN) and a legacy network are connected to each other, according to an embodiment of the present invention, includes: acquiring first network information corresponding to the SDN; acquiring second network information corresponding to the legacy network; creating a service control message for controlling a service of the network environment in which the SDN and the legacy network are connected to each other, based on at least one of the first network information and the second network information; and controlling the service of the network environment by transmitting the service control message to at least one network switch module included in the network environment.

Acquiring the first network information may be configured to acquire the first network information, including at least one of topology information, statistical information, host information, and SDN switch information, based on an OpenFlow Protocol.

Acquiring the second network information may be configured to acquire the second network information, including at least one of topology information, statistical information, host information, and legacy network module information, based on at least one of a Simple Network Management Protocol (SNMP) and a Network Configuration Protocol (Netconf).

The service control message may correspond to any one of a service creation message for adding a new service to the network environment and a service removal message for removing an existing service from the network environment.

The at least one network switch module may include at least one of at least one SDN switch and at least one legacy network switch.

Controlling the service of the network environment may comprise updating at least one of a Flow Table corresponding to the at least one SDN switch and a LookUp Table corresponding to the at least one legacy network switch, by transmitting the service control message.

When a new service is added to the network environment, controlling the service of the network environment may be configured to: add information about an entry corresponding to a new service packet to the Flow Table by delivering the service creation message to the SDN switch; and add information about an action corresponding to the new service packet to the Flow Table depending on whether the new service packet is received.

The LookUp Table may be updated when the legacy network switch receives at least one of the service creation message and a response packet to the new service packet.

The LookUp Table may delete information about the existing service after the legacy network switch does not receive a response packet to a packet corresponding to the existing service during a time period corresponding to a timeout value.

The network service control method may further include checking errors between the first network information and the second network information.

Checking the errors may be configured to: create one or more nodes corresponding to at least one of the at least one network switch module, the host, and the legacy network module; and check the errors by analyzing a relationship between the one or more nodes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a network service control system in an environment in which an SDN and a legacy network are connected to each other, according to an embodiment of the present invention;

FIG. 2 is a block diagram illustrating a network service control device in the environment in which the SDN and the legacy network are connected to each other, illustrated in FIG. 1;

FIG. 3 is a view illustrating a network environment comprising only an existing legacy network;

FIGS. 4 and 5 are views illustrating a network environment in which an SDN and a legacy network are connected to each other, according to an embodiment of the present invention;

FIG. 6 is a flowchart illustrating a network service control method in an environment in which an SDN and a legacy network are connected to each other, according to an embodiment of the present invention;

FIG. 7 is a view illustrating the process for creating a new service according to an embodiment of the present invention;

FIG. 8 is a view illustrating the process for removing an existing service according to an embodiment of the present invention;

FIG. 9 is a view illustrating the process for creating a new service according to another embodiment of the present invention; and

FIG. 10 is a view illustrating the process for updating information about network topology according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, a preferred embodiment of the present invention will be described in detail with reference to the accompanying drawings.

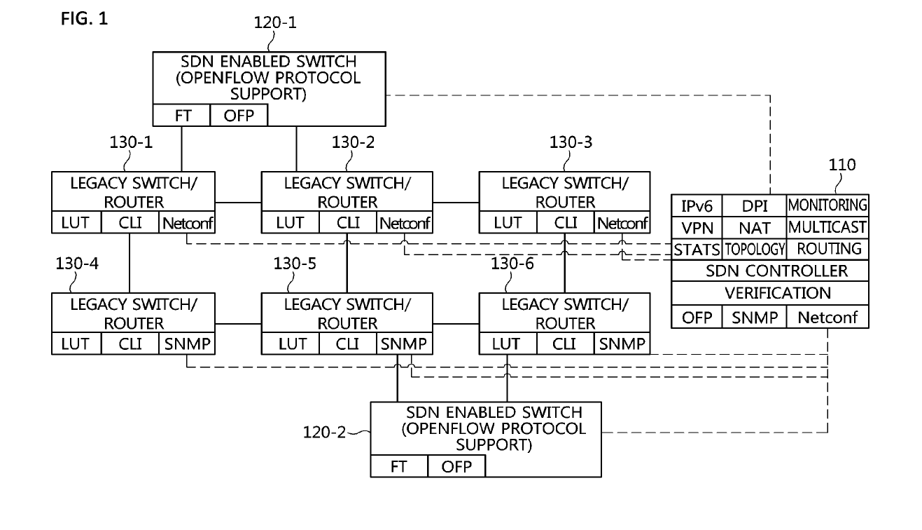

FIG. 1 is a block diagram illustrating a network service control system in an environment in which a Software Defined Network (SDN) and a legacy network are connected to each other, according to an embodiment of the present invention.

Referring to FIG. 1, a network service control system in an environment in which an SDN and a legacy network are connected to each other, according to an embodiment of the present invention, may include a network service control device 110, SDN switches 120-1 and 120-2, and legacy network switches 130-1 to 130-6.

The network service control device 110 may be a device for applying a new protocol or a new network service so as to avoid any problems in interworking between the legacy network and the SDN. For example, a protocol for interworking with the legacy network is added to the SDN in order to extend the network topology. Accordingly, a Simple Network Management Protocol (SNMP) and a Network Configuration Protocol (Netconf), which monitor information about topology, hosts, routers, and switch statistics in the legacy network, may be added to the SDN. Also, a verification module may be added in order to minimize an error that may occur when information acquired through different protocols is integrated.

The network service control device 110 may acquire first network information corresponding to the SDN.

In this case, the first network information, including at least one of topology information, statistical information, host information, and SDN switch information, may be acquired based on the OpenFlow protocol.

Also, the network service control device 110 may acquire second network information corresponding to the legacy network.

In this case, the second network information, including at least one of topology information, statistical information, host information, and legacy network module information, may be acquired based on at least one of the SNMP and Netconf.

Also, based on at least one of the first network information and the second network information, the network service control device 110 may create a service control message for removing a service from the environment in which the SDN and legacy network are connected to each other.

In this case, the service control message may correspond to any one of a service creation message for adding a new service to the network environment and a service removal message for removing an existing service from the network environment.

Also, the network service control device 110 may control the service of the network environment by transmitting the service control message to one or more network switch modules included in the network environment.

In this case, the one or more network switch modules may include at least one of one or more SDN switches 120-1 and 120-2 and one or more legacy network switches 130-1 to 130-6.

In this case, at least one of a Flow Table (FT) corresponding to the one or more SDN switches 120-1 and 120-2 and a LookUp Table (LUT) corresponding to the one or more legacy network switches 130-1 to 130-6 may be updated by transmitting the service control message.

In this case, when a new service is added to the network environment, information about an entry corresponding to a new service packet is added to the Flow Table by delivering the service creation message to the SDN switches 120-1 and 120-2, and information about an action corresponding to the new service packet may be added to the Flow Table depending on whether the new service packet is received.

In this case, when an existing service is removed from the network environment, the service module corresponding to the existing service is deactivated, and at the same time, the service removal message is delivered to the SDN switches 120-1 and 120-2, whereby information corresponding to the existing service may be deleted from the Flow Table.

In this case, the LookUp Table may be updated when the legacy network switches 130-1 to 130-6 receive at least one of the service creation message and a response packet to the new service packet.

In this case, if the legacy network switches have not received any response packet to the packet corresponding to the existing service during a time period corresponding to a timeout value, information about the existing service may be deleted from the LookUp Table.

Also, the network service control device 110 may check errors between the first network information and the second network information.

In this case, one or more nodes corresponding to at least one of one or more network switch modules, hosts, and legacy network modules are created, and the relationships between the one or more nodes are analyzed based on topology, whereby the errors may be checked.

For example, topology information and statistical information are generated by integrating information acquired from the legacy network and SDN, and based on the generated information, a forwarding path may be established in the SDN through a routing module. Also, any of applications such as VPN, NAT, Multicast, IPv6, DPI, and Monitoring may be included as a service module in the network service control device.

Also, a node of a graph is created based on a switch, router, and host. In the case of a host, an L2 or L3 address may be assigned as the ID of the node, and in the case of a switch or router, an ID distinguishable across the entire network may be assigned as the ID of the node. Then, the relationship between the nodes of the graph may be defined using the LookUp Table and Flow Table, and the nodes may be grouped based on a port or L3 subnet.

Also, error verification may be performed by finding a node of the graph corresponding to the source of an input packet and determining whether the input packet can arrive at the destination by checking the relationships between nodes in the graph, or may be performed by checking whether duplicate nodes having the same condition exist when the graph is created.

The SDN switches 120-1 and 120-2 may include a Flow Table (FT) and an Open Flow Protocol (OFP) as basic components. In this case, by communicating with the network service control device 110 through the OFP, topology information, statistical information, host information, and SDN switch information may be monitored, an SDN switch configuration may be set, and a packet may be delivered based on the FT information.

The legacy network switches may include a LookUp Table (LUT), a Command Line Interface (CLI), a Netconf, and an SNMP as basic components. In this case, a routing and forwarding table may be managed in the LUT on hardware, and the configuration of devices may be set through the CLI. Also, topology information, statistical information, host information, and network device information may be transmitted using the SNMP and Netconf.

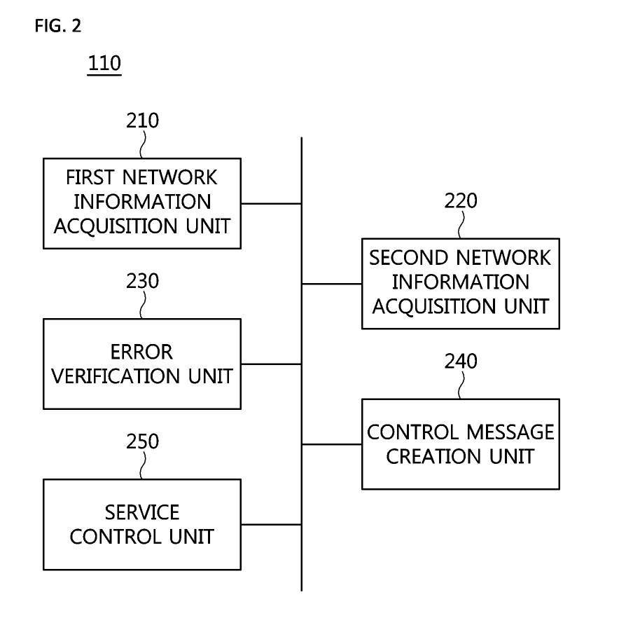

FIG. 2 is a block diagram illustrating the network service control device in the environment in which the SDN and legacy network are connected to each other, illustrated in FIG. 1.

Referring to FIG. 2, the network service control device 110 in the environment in which the SDN and legacy network are connected to each other, illustrated in FIG. 1, may include a first network information acquisition unit 210, a second network information acquisition unit 220, an error verification unit 230, a control message creation unit 240, and a service control unit 250.

The first network information acquisition unit 210 may acquire the first network information corresponding to the SDN.

In this case, the first network information, including at least one of topology information, statistical information, host information, and SDN switch information, may be acquired based on the OpenFlow protocol.

The second network information acquisition unit 220 may acquire the second network information corresponding to the legacy network.

In this case, the second network information, including at least one of topology information, statistical information, host information, and legacy network module information, may be acquired based on at least one of the SNMP and Netconf. In other words, a legacy network module may be monitored by acquiring the legacy network module information through the SNMP or Netconf.

The error verification unit 230 may check errors between the first network information and the second network information.

In this case, one or more nodes corresponding to at least one of one or more network switch modules, hosts, and legacy network modules are created, and the relationships between the one or more nodes are analyzed based on topology, whereby the errors may be checked.

For example, topology information and statistical information are generated by integrating information acquired from the legacy network and SDN, and based on the generated information, a forwarding path may be established in the SDN through a routing module. Also, any of applications such as VPN, NAT, Multicast, IPv6, DPI, and Monitoring may be included as a service module in the network service control device.

Also, a node of a graph is created based on a switch, router, and host. In the case of a host, an L2 or L3 address may be assigned as the ID of the node, and in the case of a switch or router, an ID distinguishable across the entire network may be assigned as the ID of the node. Then, the relationship between the nodes of the graph may be defined using the LookUp Table and Flow Table, and the nodes may be grouped based on a port or L3 subnet.

Also, error verification may be performed by finding a node of the graph corresponding to the source of an input packet and determining whether the input packet can arrive at the destination by checking the relationships between nodes in the graph, or may be performed by checking whether duplicate nodes having the same condition exist when the graph is created.

The control message creation unit 240 may create a service control message for removing a service from the environment in which the SDN and legacy network are connected to each other, based on at least one of the first network information and the second network information.

In this case, the service control message may correspond to one of a service creation message for adding a new service to the network environment, and a service removal message for removing an existing service from the network environment.

The service control unit 250 may control the service of the network environment by transmitting the service control message to one or more network switch modules included in the network environment.

In this case, the SDN may be controlled using the OpenFlow protocol.

Also, the configuration of the legacy network modules may be set through the CLI, and the configuration may be changed individually for each of the modules. In this case, if a CLI module that may interwork with the CLI of the legacy network is added to the network service control device, integrated control may be performed through the network service control device.

In this case, the one or more network switch modules may include at least one of one or more SDN switches and one or more legacy network switches.

In this case, at least one of a Flow Table corresponding to the one or more SDN switches and a LookUp Table corresponding to the one or more legacy network switches may be updated by transmitting the service control message.

In this case, when a new service is added to the network environment, information about an entry corresponding to a new service packet is added to the Flow Table by delivering the service creation message to the SDN switches, and information about an action corresponding to the new service packet may be added to the Flow Table depending on whether the new service packet is received.

In this case, when an existing service is removed from the network environment, the service module corresponding to the existing service is deactivated, and at the same time, the service removal message is delivered to the SDN switches, whereby information corresponding to the existing service may be deleted from the Flow Table.

In this case, the LookUp Table may be updated when the legacy network switches receive at least one of the service creation message and a response packet to the new service packet.

In this case, if the legacy network switches have not received any response packet to the packet corresponding to the existing service during a time period corresponding to a timeout value, information about the existing service may be deleted from the LookUp Table.

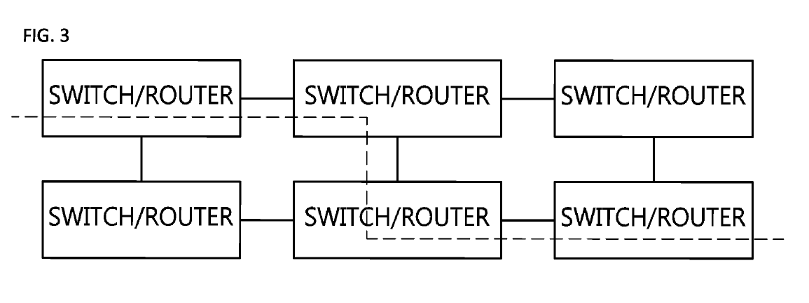

FIG. 3 is a view illustrating a network environment comprising only an existing legacy network.

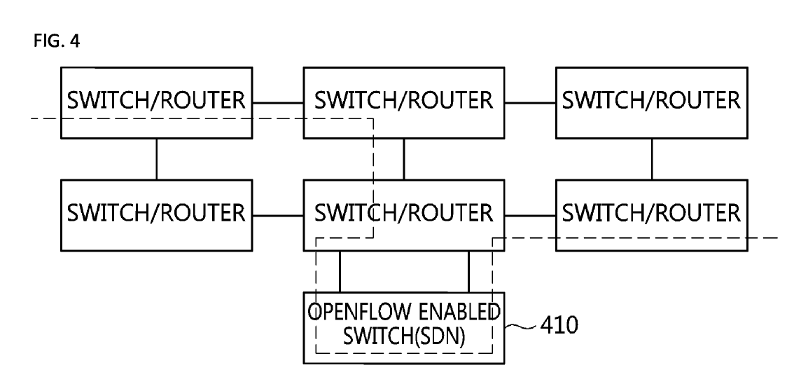

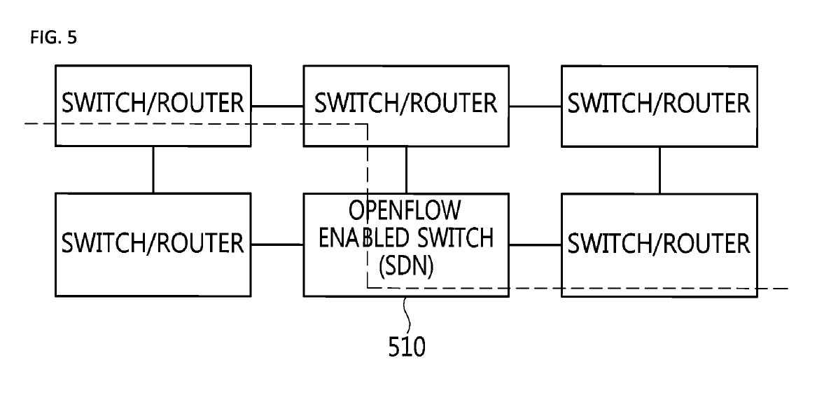

FIGS. 4 and 5 are views illustrating a network environment in which an SDN and a legacy network are connected to each other, according to an embodiment of the present invention.

Referring to FIGS. 3 to 5, when an SDN module is added to the network environment comprising only the legacy network, the SDN module may be added without changing the existing network topology, as illustrated in FIG. 4.

Also, as illustrated in FIG. 5, a module of the existing network topology may be substituted by an SDN module.

In this case, when an SDN module substitutes for the module of the existing network topology as shown in FIG. 5, a service may be provided without needing to change the configuration of other modules, whereas when a new SDN module is added as shown in FIG. 4, it may be necessary to change some of the existing routing tables.

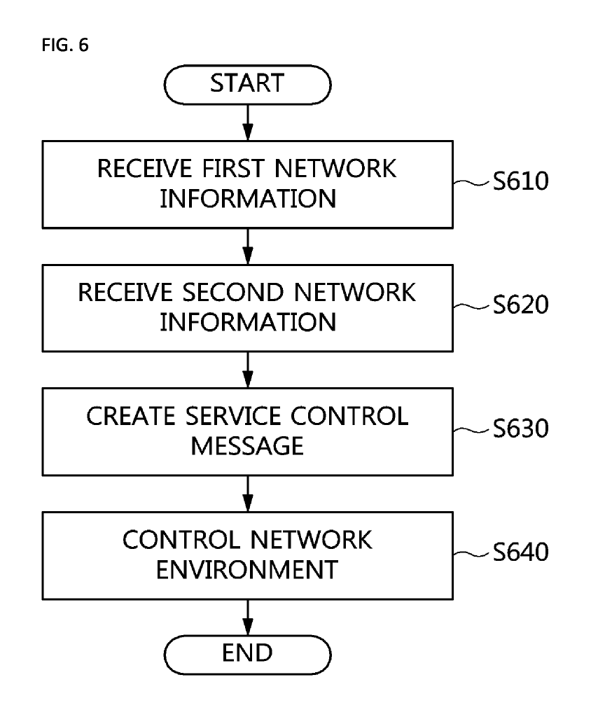

FIG. 6 is a flowchart illustrating a network service control method in an environment in which an SDN and a legacy network are connected to each other according to an embodiment of the present invention.

Referring to FIG. 6, a network service control method in an environment in which an SDN and a legacy network are connected to each other according to an embodiment of the present invention may acquire the first network information corresponding to the SDN at step S610.

In this case, the first network information, including at least one of topology information, statistical information, host information, and SDN switch information, may be acquired based on the OpenFlow protocol.

Also, the network service control method in the environment in which the SDN and the legacy network are connected to each other according to an embodiment of the present invention may acquire the second network information corresponding to the legacy network at step S620.

In this case, the second network information, including at least one of topology information, statistical information, host information, and legacy network module information, may be acquired based on at least one of the SNMP and Netconf. In other words, a legacy network module may be monitored by acquiring the legacy network module information through the SNMP or Netconf.

Also, the network service control method in the environment in which the SDN and the legacy network are connected to each other according to an embodiment of the present invention may create a service control message for removing a service from the environment in which the SDN and legacy network are connected to each other, based on at least one of the first network information and the second network information at step S630.

In this case, the service control message may correspond to one of a service creation message for adding a new service to the network environment and a service removal message for removing an existing service from the network environment.

Also, the network service control method in the environment in which the SDN and the legacy network are connected to each other according to an embodiment of the present invention may control the service of the network environment by transmitting the service control message to one or more network switch modules included in the network environment at step S640.

In this case, the SDN may be controlled using the OpenFlow protocol.

Also, the configuration of the legacy network modules may be set through the CLI, and the configuration may be changed individually for each of the modules. In this case, if a CLI module that may interwork with the CLI of the legacy network is added to the network service control device, integrated control may be performed through the network service control device.

In this case, the one or more network switch modules may include at least one of one or more SDN switches and one or more legacy network switches.

In this case, at least one of a Flow Table corresponding to the one or more SDN switches and a LookUp Table corresponding to the one or more legacy network switches may be updated by transmitting the service control message.

In this case, when a new service is added to the network environment, information about an entry corresponding to a new service packet is added to the Flow Table by delivering the service creation message to the SDN switches, and information about an action corresponding to the new service packet may be added to the Flow Table depending on whether the new service packet is received.

In this case, when an existing service is removed from the network environment, the service module corresponding to the existing service is deactivated, and, at the same time, the service removal message is delivered to the SDN switches, whereby information corresponding to the existing service may be deleted from the Flow Table.

In this case, the LookUp Table may be updated when the legacy network switches receive at least one of the service creation message and a response packet to the new service packet.

In this case, if the legacy network switches have not received any response packet to the packet corresponding to the existing service during a time period corresponding to a timeout value, information about the existing service may be deleted from the LookUp Table.

Also, although not illustrated in FIG. 6, the network service control method in the environment in which the SDN and the legacy network are connected to each other according to an embodiment of the present invention may check errors between the first network information and the second network information.

In this case, one or more nodes corresponding to at least one of one or more network switch modules, hosts, and legacy network modules are created, and the relationships between the one or more nodes are analyzed based on topology, whereby the errors may be checked.

For example, topology information and statistical information are generated by integrating information acquired from the legacy network and SDN, and based on the generated information, a forwarding path may be established in the SDN through a routing module. Also, any of applications such as VPN, NAT, Multicast, IPv6, DPI, and Monitoring may be included as a service module in the network service control device.

Also, a node of a graph is created based on a switch, router, and host. In the case of a host, an L2 or L3 address may be assigned as the ID of the node, and in the case of a switch or router, an ID distinguishable across the entire network may be assigned as the ID of the node. Then, the relationship between the nodes of the graph may be defined using the LookUp Table and Flow Table, and the nodes may be grouped based on a port or L3 subnet.

Also, error verification may be performed by finding a node of the graph corresponding to the source of an input packet and determining whether the input packet can arrive at the destination by checking the relationships between nodes in the graph, or may be performed by checking whether duplicate nodes having the same condition exist when the graph is created.

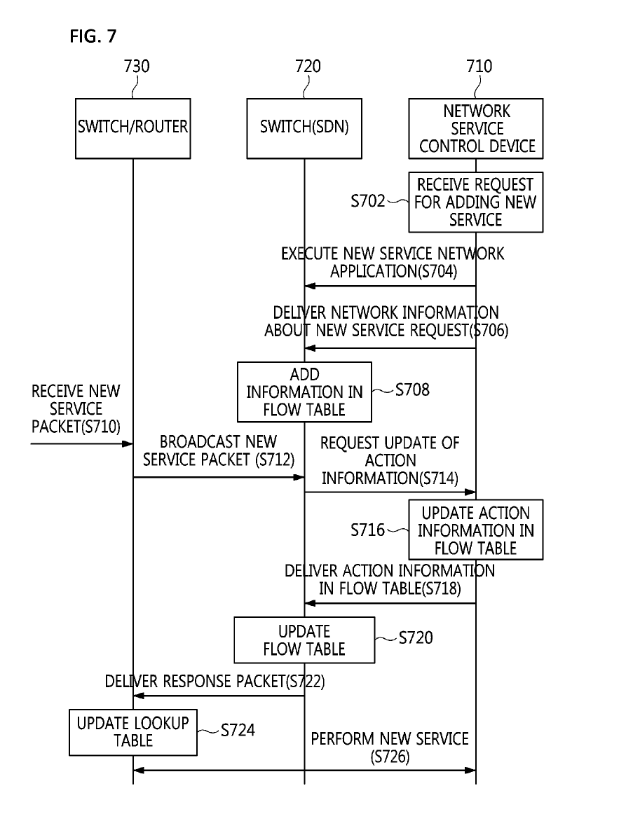

FIG. 7 is a view illustrating a process for creating a new service according to an embodiment of the present invention.

Referring to FIG. 7, in the process for creating a new service according to an embodiment of the present invention, when a network service control device 710 receives a request for adding a new service from a user at step S702, it requests an SDN switch 720 to execute a new service network application at step S704 while delivering the network information about the new service request to the SDN switch at step S706.

In this case, both information about the request for execution of the new service network application and the network information may be included in the service creation message to be delivered.

Then, the SDN switch 720 may add information about the new service in the Flow Table based on the delivered information at step S708.

In this case, only entry information for the new service may be updated. That is, action information for processing a new service packet may not have been added.

Then, when the legacy network switch 730 receives a new service packet at step S710 and delivers the new service packet to the SDN switch 720 by broadcasting it at step S712, the SDN switch 720 may request the network service control device 710 to update the action information for the new service packet at step S714.

Then, the network service control device 710 may update action information of the Flow Table based on topology information and statistical information at step S716, and may deliver the updated action information of the Flow Table to the SDN switch 720 at step S718.

Then, the SDN switch 720 may update action information for the new service, stored in the Flow Table, using the received action information at step S720.

Then, the SDN switch 720 may deliver a response packet to the new service packet through a path corresponding to the updated action information of the Flow Table at step S722.

Then, the legacy network switch 730 may update information about the new service in the LookUp table through the response packet at step S724, and may run the new service in the network environment at step S726.

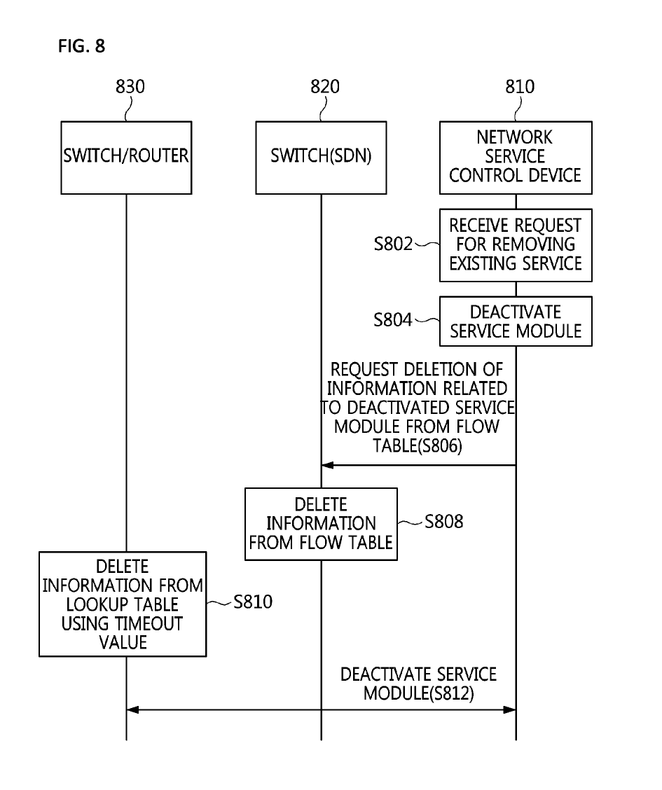

FIG. 8 is a view illustrating a process for removing an existing service according to an embodiment of the present invention.

Referring to FIG. 8, in the process for removing an existing service according to an embodiment of the present invention, when a network service control device 810 receives a request for removal of an existing service from a user at step S802, the network service control device 810 deactivates the service module, requested to be removed, at step S804, and may request an SDN switch 820 to delete information, related to the deactivated service module, from the Flow Table at step S806.

Then, the SDN switch 820 may delete the information about the service, requested to be deleted, from the Flow Table at step S808.

Also, if a legacy network switch 830 has not received a response packet to the service module that has been requested to be deleted during a time period corresponding to a predetermined timeout value, the legacy network switch 830 may delete the information related to the service module that was requested to be deleted from the LookUp Table at step S810.

Accordingly, the service module, removed from the network environment, may be deactivated at step S812.

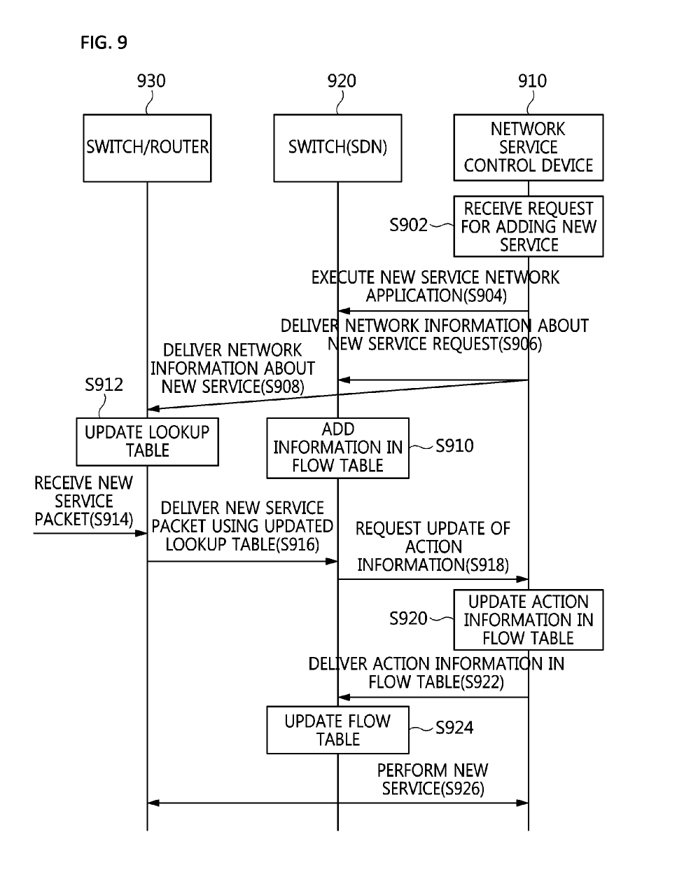

FIG. 9 is a view illustrating a process for creating a new service according to another embodiment of the present invention.

Referring to FIG. 9, the process for creating a new service according to another embodiment of the present invention is similar to the process of FIG. 7, but in the process of FIG. 9, it may be assumed that a network service control device 910 includes a CLI module for controlling a legacy network.

When the network service control device 910 receives a request for adding a new service from a user at step S902, it requests an SDN switch 920 to execute a new service network application at step S904 and may deliver the network information about the new service request to both the SDN switch 920 and a legacy network switch 930 at steps S906 and S908, unlike the process of FIG. 7.

Then, the SDN switch 920 may add information about the new service to the Flow Table based on the delivered information at step S910, and the legacy network switch 930 may update the LookUp Table by adding information about the new service based on the delivered information at step S912.

Here, only entry information for the new service may be updated in the Flow Table. Namely, action information for processing a new service packet may not have been added.

Then, when the legacy network switch 930 receives a new service packet at step S914, it may deliver the new service packet to the SDN switch 920 using the updated LookUp Table at step S916, unlike the process of FIG. 7.

Then, the SDN switch 920 may request the network service control device 910 to update the action information for the new service packet at step S918.

Then, the network service control device 910 updates action information of the Flow Table based on topology information and statistical information at step S920, and may deliver the updated action information of the Flow Table to the SDN switch 920 at step S922.

Then, the SDN switch 920 may update action information for the new service, stored in the Flow Table, using the received action information at step S924.

Then, the new service may be performed in the network environment at step S926.

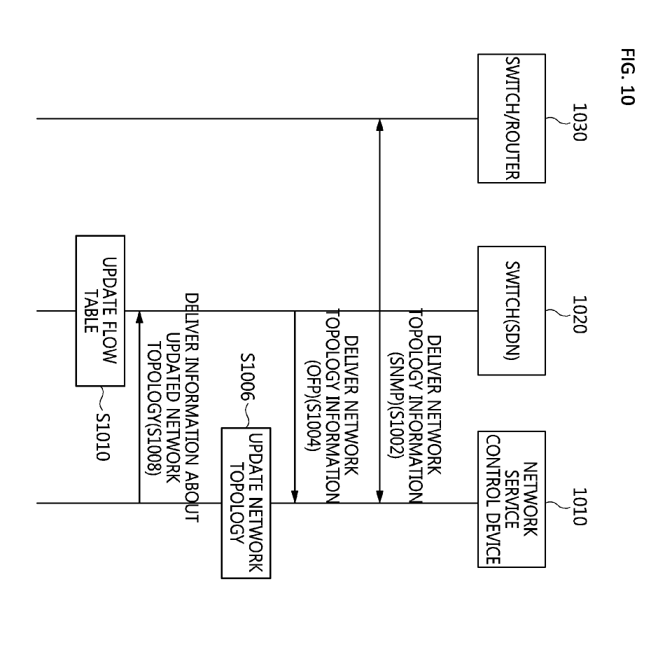

FIG. 10 is a view illustrating a process for updating network topology information according to an embodiment of the present invention.

Referring to FIG. 10, in the process for updating the network topology information according to an embodiment of the present invention, a legacy network switch 1030 and an SDN switch 1020 may deliver network topology information to a network service control device 1010 using the SNMP and OFP, respectively, at steps S1002 and S1004.

Then, the network service control device 1010 may update the network topology information based on the received legacy network topology information and SDN topology information at step S1006.

Then, the network service control device 1010 may deliver the updated topology information to the SDN switch 1020 at step S1008, so that SDN switch 1020 may update the Flow Table at step S1010.

In other words, the network topology information, managed by the network service control device 1010, is periodically updated through the process of FIG. 10, or may be updated when an event occurs.

Also, whenever topology information is updated, the SDN switch 1020 may update the Flow Table to correspond to the updated topology.

As described above, the network service control device and method in an environment in which an SDN and a legacy network are connected to each other, according to the present invention, are not limitedly applied to the configurations and operations of the above-described embodiments, but all or some of the embodiments may be selectively combined and configured so that the embodiments may be modified in various ways.

According to the present invention, an SDN may interwork with an existing legacy network.

Also, the present invention may provide a control method capable of adding and removing a network service or a protocol in an environment in which a legacy network and an SDN are connected to each other.

What is claimed is:

1. A network service control device in an environment in which a Software Defined Network (SDN) and a legacy network are connected to each other, comprising:
a first network information acquisition unit for acquiring first network information corresponding to the SDN;
a second network information acquisition unit for acquiring second network information corresponding to the legacy network;
a control message creation unit for creating a service control message for controlling a service of the network environment in which the SDN and the legacy network are connected to each other, based on at least one of the first network information and the second network information; and
a service control unit for controlling the service of the network environment by transmitting the service control message to at least one network switch module included in the network environment.

2. The network service control device of claim 1, wherein the first network information acquisition unit acquires the first network information including at least one of topology information, statistical information, host information, and SDN switch information, based on an OpenFlow Protocol.

3. The network service control device of claim 2, wherein the second network information acquisition unit acquires the second network information including at least one of topology information, statistical information, host information, and legacy network module information, based on at least one of a Simple Network Management Protocol (SNMP) and a Network Configuration Protocol (Netconf).

4. The network service control device of claim 3, wherein the service control message corresponds to any one of a service creation message for adding a new service to the network environment and a service removal message for removing an existing service from the network environment.

5. The network service control device of claim 4, wherein the at least one network switch module includes at least one of at least one SDN switch and at least one legacy network switch.

6. The network service control device of claim 5, wherein the service control unit updates at least one of a Flow Table corresponding to the at least one SDN switch and a LookUp Table corresponding to the at least one legacy network switch, by transmitting the service control message.

7. The network service control device of claim 6, wherein when a new service is added to the network environment, the service control unit adds information about an entry corresponding to a new service packet to the Flow Table by delivering the service creation message to the SDN switch, and adds information about an action corresponding to the new service packet to the Flow Table depending on whether the new service packet is received.

8. The network service control device of claim 6, wherein when an existing service is removed from the network environment, the service control unit deactivates a service module corresponding to the existing service, and simultaneously delivers the service removal message to the SDN switch so as to delete information corresponding to the existing service from the Flow Table.

9. The network service control device of claim 7, wherein the LookUp Table is updated when the legacy network switch receives at least one of the service creation message and a response packet to the new service packet.

10. The network service control device of claim 8, wherein the LookUp Table deletes information about the existing service after the legacy network switch does not receive a response packet to a packet corresponding to the existing service during a time period corresponding to a timeout value.

11. The network service control device of claim 3, further comprising:
an error verification unit for checking errors between the first network information and the second network information.

12. The network service control device of claim 11, wherein the error verification unit creates one or more nodes corresponding to at least one of the at least one network switch module, the host, and the legacy network module, and checks errors by analyzing a relationship between the one or more nodes.

13. A network service control method in an environment in which a Software Defined Network (SDN) and a legacy network are connected to each other, comprising:
acquiring first network information corresponding to the SDN;
acquiring second network information corresponding to the legacy network;
creating a service control message for controlling a service of the network environment in which the SDN and the legacy network are connected to each other, based on at least one of the first network information and the second network information; and
controlling the service of the network environment by transmitting the service control message to at least one network switch module included in the network environment.

14. The network service control method of claim 13, wherein acquiring the first network information is configured to acquire the first network information, including at least one of topology information, statistical information, host information, and SDN switch information, based on an OpenFlow Protocol.

15. The network service control method of claim 14, wherein acquiring the second network information is configured to acquire the second network information, including at least one of topology information, statistical information, host information, and legacy network module information, based on at least one of a Simple Network Management Protocol (SNMP) and a Network Configuration Protocol (Netconf).

16. The network service control method of claim 15, wherein the service control message corresponds to any one of a service creation message for adding a new service to the network environment and a service removal message for removing an existing service from the network environment.

17. The network service control method of claim 16, wherein the at least one network switch module includes at least one of at least one SDN switch and at least one legacy network switch.

18. The network service control method of claim 17, wherein controlling the service of the network environment comprises updating at least one of a Flow Table corresponding to the at least one SDN switch and a LookUp Table corresponding to the at least one legacy network switch, by transmitting the service control message.

19. The network service control method of claim 18, wherein when a new service is added to the network environment, controlling the service of the network environment is configured to:
add information about an entry corresponding to a new service packet to the Flow Table by delivering the service creation message to the SDN switch; and
add information about an action corresponding to the new service packet to the Flow Table depending on whether the new service packet is received.

20. The network service control method of claim 15, further comprising,
checking errors between the first network information and the second network information,
wherein checking the errors is configured to:
create one or more nodes corresponding to at least one of the at least one network switch module, the host, and the legacy network module; and
check the errors by analyzing a relationship between the one or more nodes.
